(19) United States
(12) Patent Application Publication
(10) Pub. No.: US 2023/0274323 A1
(43) Pub. Date: Aug. 31, 2023

(54) Method, System and Apparatus for Determining a Recommendation

(71) Applicant: International WELL Building Institute pbc, New York, NY (US)

(72) Inventors: Minjia Yang, Jersey City, NJ (US); Matthew John Trowbridge, Charlottesville, VA (US); Whitney Austin Gray, New York, NY (US); Angela Lynn Loder, Denver, CO (US)

(21) Appl. No.: 18/114,053

(22) Filed: Feb. 24, 2023

Related U.S. Application Data
(60) Provisional application No. 63/313,872, filed on Feb. 25, 2022.

(51) Int. Cl. G06Q 30/0282; G06Q 30/0203

(52) U.S. Cl. CPC G06Q 30/0282; G06Q 30/0203

(57) ABSTRACT

A method and system is disclosed for providing a recommendation to an individual, company, governmental agency, community, insurance provider, health care provider, therapy or counseling provider, association, organization, product developer, manufacturer or supplier, or other entity or group may be based on one or more of index data, index result, benchmarking result, reporting document, reporting standard, human capital management plan, trend or data, social capital plan, trend or data, insurance coverage, obligation or need, policy, market or competitor analysis, regulatory requirement or data, etc. A recommendation may relate to many things, such as a policy, obligation, marketing or other business strategy, insurance coverage, ESG (environmental, social and governance) related goal, investment portfolio selection, financial return goal, reporting activity, content creation, distribution or use activity, product or service feature, etc. provided, created or used by an organization.

### RELATED APPLICATION(S)

This application claims the benefit of U.S. Provisional application No. 63/313,872, filed Feb. 25, 2022, which is incorporated by reference in its entirety herein.

### TECHNICAL FIELD

These teachings relate generally to collecting and analyzing data for organizational performance and, in particular, to collecting and analyzing data for environmental, social and governance (ESG) performance of an organization.

### BACKGROUND

Companies often seek to employ evidence-based metrics to guide and improve the management of their organization, including to manage or improve their human and social capital. Human capital may include the knowledge, skills, and experience formed by investment in education and training. Social capital may include the interpersonal network formed by relationship investment. In addition, companies may face pressure from investors or other stakeholders to better define, track, and measure strategies with respect to human and social capital. Human and social capital, however, may be difficult to measure. Thus, there may be challenges placing metrics around social and human capital and tracking metrics and leveraging such capital to guide in strategies and business decisions. In addition, there may be challenges in measuring and tracking the impact of investments in health and well-being.

### BRIEF DESCRIPTION OF THE DRAWINGS

Various needs are at least partially met through provision of the methods, system, and apparatus for determining a recommendation described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a schematic diagram of a system for determining or generating a recommendation.

FIG. 2 is a flow diagram of a first embodiment of a method of determining a recommendation.

FIG. 3 is a flow diagram of a second embodiment of a method of determining a recommendation.

FIG. 4 is a flow diagram of a third embodiment of a method of determining a recommendation.

FIG. 5 is a flow diagram of a fourth embodiment of a method of determining a recommendation.

FIG. 6 is a flow diagram of a fifth embodiment of a method of determining a recommendation.

FIG. 7 is a flow diagram of a sixth embodiment of a method of determining a recommendation.

FIG. 8 is a flow diagram of a seventh embodiment of a method of determining a recommendation.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

An organization or one or more people associated with an organization may need or want to define, track, measure and report their human and social capital strategies as part of their environmental, social and governance (ESG) and other regulatory reporting. Health and well-being related metrics may be included as a component of such human and social capital strategies or reporting.

Embodiments of the invention disclosed herein include methods and system for providing a recommendation to an individual, company, governmental agency, community, insurance provider, health care provider, therapy or counseling provider, association, organization, product developer, manufacturer or supplier, or other entity or group may be based on one or more of index data, index result, benchmarking result, reporting document, reporting standard, human capital management plan, trend or data, social capital plan, trend or data, insurance coverage, obligation or need, policy, policy change market or competitor analysis, regulatory requirement or data, etc. A recommendation may relate to many things, such as a policy, obligation, marketing or other business strategy, insurance coverage, ESG (environmental, social and governance) related goal, investment portfolio selection, financial return goal, reporting activity, content creation, distribution or use activity, product or service feature, etc. provided, created or used by an organization. Data may be stored in or accessible or ascertainable from, one or more databases, reports, other materials or content, etc.

In some embodiments, an organization may include one or more of the following: a public company; a part of a public company; a private company; a part of a private company; a for-profit organization; a non-profit organization; a financial services provider; a real estate developer, manager or owner a counseling or therapy provider; a group of at least two individuals; a group of at least two public companies; a group of at least two private companies; a group of at least two for-profit organizations; a group of at least two non-profit organizations; a community related association or other group; a governmental agency; an insurance provider; an insurance related services provider; a health care or medical service or product provider; a counseling or therapy provider; an information collector or provider; an education or training provider; or a product or product component developer or manufacturer. In some embodiments, a recommendation may relate to one or more of the following: at least one policy of an organization; at least one obligation of an organization; a business strategy of an organization; insurance coverage of an organization; an ESG goal of an organization; a human capital related goal of an organization; a social capital related goal of an organization; a new financial product or service; a new investment; at least one strategy component of an organization; at least one reporting activity of an organization; at least one content creation activity of an organization; at least one content sharing activity of an organization; at least one strategy component of an organization; at least one feature of at least one product provided by an organization; at least one feature of at least one service provided by an organization; at least one feature of at least one product used by an organization; at least one feature of at least one service used by an organization; or at least one feature of at least one policy implemented or under evaluation by an organization.

Further embodiments may include obtaining, accessing, sending, analyzing or receiving a signal or data indicative of for an organization one or more of the following: a recommendation or a portion thereof, index related data, heath or well-being related metric, a benchmarking result, an index result, strategy component, human capital or social capital trend.

Further embodiments may include one or more of the following: receiving or otherwise obtaining index data and determining or generating at least one recommendation based, at least in part, on the index data; obtaining data indicative of an index result and determining at least one recommendation for an investment decision based, at least in part, on the data; obtaining data indicative of an index result and determining at least one new financial product based, at least in part, on the data; obtaining data indicative of at least one benchmarking result and determining a recommendation based, at least in part, on the data; obtaining data related to at least one reporting standard, determining at least one strategy element based, at least in part, on the at least one reporting standard; and implementing at least a portion of the strategy element; obtaining data related to at least one reporting standard, determining at least one reporting element based, at least in part, on the at least one reporting standard, and implementing at least a portion of the reporting element; obtaining data related to at least one of human capital management and social capital management, determining at least one recommendation based, at least in part, on the data, and implementing at least a portion of the at least one recommendation; obtaining data related to at least one of human capital data and social capital data, determining at least one recommendation based, at least in part, on the data, an implementing at least a portion of the at least one recommendation; obtaining data related to at least one of human capital trend and social capital trend, determining at least one recommendation based, at least in part, on the data, implementing at least a portion of the at least one recommendation; comprising conducting market analysis based, at least in part, on data obtained, accessed, received or sent; or accessing, collecting, receiving or otherwise obtaining, determining or sharing data indicative of at least a portion of human capital data or social capital data. Some or all of the data may be stored in, shared with, downloadable or otherwise available from, etc., one or more databases or other devices or resources.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and devices, such as computing systems, as well as networks and other communications channels have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this disclosure to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this disclosure and the appended claims, the singular forms “a,” “an,” and “the” include plural referents unless the content clearly dictates otherwise. It should also be noted that the term “or” is generally employed in its sense including “and/or” unless the content clearly dictates otherwise.

It is getting more common for an organization or one or more people associated with an organization to need or want to define, track, measure and report their human and social capital strategies as part of their environmental, social and governance (ESG) and other regulatory reporting. In addition, there is a growing desire that health, well-being and equity related metrics be included as a component of such human and social capital strategies. This may include building, measuring or using an understanding of how an organization may measure human health, well-being and equity metrics and the impact of such metrics on their employees, policies, strategies, success determinations, locations, partners, suppliers, product and service design and implementation, distribution channels, investors, the planet, etc. In some embodiments, the building, measuring or understanding may be organized by or use dimensions adapted from a public health socio-ecological framework. The socioecological framework can show how health outcomes are the result of multiple interconnected dimensions of influence, including: individual, organizational, environmental, community, and global dimensions. Within each dimension, there may be themes or other attributes that provide benchmarkable areas for tracking and represent target areas for achievement or “competency” for organizations. Each competency theme can be supported by measurement metrics and questions for data collection and analysis. Dimension and theme scores may then be determined may then be created in different ways such as, for example, by deriving scores from underlying question scores with potential impact by media and stakeholder analysis multipliers, weighting factors, etc.

There often is little consensus for what organizations should measure as part of annual Corporate Sustainability Reporting (CSR), Environmental Social Governance (ESG) disclosures, sustainable finance framework and reporting, etc. This ambiguity can lead to a mishmash of metrics or key performance indicators (KPI) used by organizations, often with a lack of understanding of what the metric or KPI is actually measuring or why it is being used, or if it can be applied across companies and other organizations to enable consistent, better and more comparable benchmarking and tracking over time.

In some situations, benchmarks or other metrics may be used to create or change an index, fund or other financial product or service that can be measured and better aligned with sustainability, human capital, social capital, etc. This may be particularly helpful in situations when the performance of such index, fund or other financial product or service is different from the tracking the performance or progress of an organization, or between organizations, over time, regarding its policies, investments, strategy, human capital management, social capital management, etc.

A good example of this is absenteeism, a common metric and stand-in for health status in organizational reporting. Without further context on whether an employee was absent for health-related or other reasons (e.g., a sick child) the data often is not a strong measure by itself of the health of the employee. It is also can be useless or otherwise unhelpful for companies that do not give sick days or vacation time but rather the combined Paid Time Off (PTO) popular in the U.S. In order to strengthen this measure, additional factors must be accounted for that can impact why an employee is absent, such as poor air quality or a lack of engagement. Adding performance testing data on air quality or employee survey results can help clarify whether the absenteeism is related to building-related asthma, a lack of engagement, or other reasons, such as:

Tracking investment in workplace wellness programs, but not tracking the actual employee utilization levels or employee health impacts;

Investing in apps for employee mindfulness without looking at other influencing factors on mental health, thus shifting the problem of an organizational-level burnout culture to individual-level burnout prevention;

Selecting individual-level metrics to show ‘progress’ on issues like diversity (e.g., number of people of color hired) when a holistic organization-wide approach is needed (e.g., understanding systemic bias in recruitment and hiring);

Tracking lagging factors of disease and injury (e.g., burnout) while not understanding the impact that leading factors (such as having an environment of care and support) have on those outcomes; or

Focusing on safety and accessibility inside the building but neglecting to evaluate safety, accessibility, and community engagement in the immediate neighborhood, leading to vulnerable employees feeling unsafe getting to/from work.

Such situations can contribute to a lack of confidence by and in organizations regarding the value of investing in people since they do not understand how to capture the results of the investment.

In some embodiments, an organization might be or include one or more of the following: a public company a part of a public company; a private company; a part of a private company; a for-profit organization; a non-profit organization; a group of at least two public companies; a group of at least two private companies; a group of at least two for-profit organizations; a group of at least two non-profit organizations; a group of at least two individuals; a community related association or other group; a governmental agency; an insurance provider; an insurance related services provider; a financial services provider; a health care or medical service or product provider; a real estate developer, manager or owner a counseling or therapy provider; an information collector, analyzer, or provider; an education or training provider; a product or product component developer or manufacturer; etc.

Health, wellness, well-being, and equity related topics, risks and issues, as well as individual and organizational performance and how such performance is measured and relates to health, wellness, well-being and equity, are becoming more important to organizations, investors, regulators, individuals, communities, and other stakeholders. An organization, or one or more individuals associated with an organization may benefit from a framework for identifying and tracking relevant metrics and a common language for communicating their strategies in a variety of areas. This may then allow them to measure, benchmark and communicate commitments, goals, priorities, KPIs, etc. related to human and social capital management at an individual, organizational and social level and scale.

For example, users of the methods disclosed herein may include one or more of the following, and benefits to such users may include one or more of the following:
Sustainability managers: Benchmark well-being, diversity, equity and inclusion or human capital performance or progress internally or against peers on aggregated level.
Index providers: Incorporate well-being, diversity, equity and inclusion or human capital specific or holistic metrics and scores into indexes.
Corporations and investment funds: Perform well-being diversity, equity and inclusion or human capital due diligence prior to mergers & acquisitions or strategic investments for avoiding or at least reducing costly talent integration or retention post transaction.
Credit rating agencies: Improve ESG assessments in credit rating with expanded coverage of well-being/human capital specific indicators.
Asset managers: Conduct Human capital/social impact portfolio analysis, identify human capital signals for quantitative models, and screen for human capital performance or progress.
Procurement managers: Identify well-being, diversity, equity and inclusion or human capital risks and opportunities in a supplier portfolio without or with a reduction in the negative burden on suppliers from questionnaires.
Compliance managers: Access data for regulatory compliance and identify potential exposure to legislation such as Sustainable Finance Disclosure Regulation (SFDR).
Business development professionals: Discover development opportunities through well-being, diversity, equity and inclusion or human capital insight into peers, partners and industry performance or progress.
Consultants: Create value for existing clients and attract new clients with unique well-being, diversity, equity and inclusion or human capital data insights such as industry or peer benchmark.
Data platforms: Expand ESG data with expanded coverage of well-being, diversity, equity and inclusion or human capital specific indicators and data points.
Financial analysts: Use well-being, diversity, equity and inclusion or human capital index data for company or sector attribution to determine what is driving individual stock prices and to make buy/sell recommendations.
Hedge fund analysts: Use real-time well-being, diversity, equity and inclusion or human capital data to identify quantitative signals that have historically represented buy or sell opportunities.
Chief financial officers and chief sustainability officers: Incorporate well-being, diversity, equity and inclusion or human capital indicators into long-term organizational ESG strategies, roadmaps, and sustainable finance frameworks for sustainability-linked bond, sustainability-linked loan, green bond, social bond, and other financial instruments.
Government officials or agency: Track healthcare costs, jobs and other human capital factors to inform a government view on policy.
Media and academic professionals: Access a well-being, diversity, equity and inclusion or human capital database for new or improved research and articles.
ther: Organizations looking to improve the health, wellness and well-being of their employees.

As further examples looking at different levels and scales, an organization, community, individual, group, etc. may want to achieve one or more of the following:
Individal Sale: Improving a person's′ mental and physical health and well-being, resiliency and performance.
Environmental Scale: Creating and use of workplaces with human-centric design.
Organizational Scale: Embracing and practicing a culture of health, wellbeing and equity that supports performance, progress, resilience, and thriving.
Community Scale: More engaged and inclusive communities.
Global Scale: Transparent and consistent ESG reporting and human and social capital performance and progress tracking and use by organizations globally.

Obtaining and using the right data, using methods to measure and compare these scales within and across different organizations, and for tracking and benchmarking accurate reflections of health, well-being, social capital, human capital, etc., and the progress and performance of them is an improvement over many methods and practices used currently and may help create a more valuable and useful index.

There are many ways for measuring health, wellness, well-being and diversity, equity and inclusion. For example, in some embodiments, data employed in the methods and systems described herein may include organizational data that includes one or more of following:
Data related to or including information regarding an organization or the organization's initiatives, policies, etc., related to sustainability, ESG, corporate social responsibility, sustainable finance and other disclosures that include or refer to organizational health and well-being initiatives, health and safety data, sustainability strategy, social and environmental impact investments, employees' health, well-being, engagement, performance and productivity data, response to Covid-19 pandemic, climate change and physical risk mitigation strategies, diversity, equity and inclusion (DEI) policies, community engagement projects and policies, human and social capital, etc.
Data related to or including information regarding executive and other employee dialogues focusing on the above topics and any other issues regarding an organization's long term strategy on human and social capital management and associated challenges and risks.
Data related to or including information regarding specialized government, academic, ESG benchmarking/index data sets such as S&P Dow Jones Sustainability Indices, GRESB ESG benchmark, IRIS+ platform for impact investment, etc., focusing on the above topics and any other data on human resources, organizational governance, sustainability focused real estate portfolio, investment portfolio or organizational performance or progress.
Data related to or including information regarding media searches to identify or screen risks to organizations' reputation and long-term development including lawsuits, negative impact to society and environment and associated penalties, major disputes among stakeholders, etc.

Data employed by the methods and systems described herein may also include individual data may also include data related to or including information on individual related metrics such as measurements of and other metrics related to one or more of the following:
the state or status of an individual's physical and mental health, mental health resilience, health impacting behaviors, other lifestyle choices and behaviors, etc.
an individuals' work-life balance, role strain, purpose, energy level, ability to recharge, reduce or deal with stress, amount of physical exercise, amount and quality of sleep, etc.
how the individual is or is not thriving, the individual's work structure and relationships, work engagement, perceived care and support, etc.
an individual's perceived focus or ability to focus, attention, performance, job satisfaction, life satisfaction, trust in colleagues and employers, work-life balance, ability to recharge, perceived organizational care, etc.

Individual data may include any type of data related to or including information on heath and/or wellbeing of an individual, thriving of an individual, performance of an individual, and/or employee effectiveness.

Data employed in the methods and systems described herein may also include organizational data related to or including information on organizational related metrics, such as measurements of and other metrics related to one or more of the following:
organizational performance or progress, financial performance or progress, leadership and employee effectiveness, financial position, perceived employee effectiveness score, perceived employee sense of place, etc.
organizational strategy and execution, structure, relationships and communication, talent management, engagement, etc.
an organization's diversity, equity and inclusion, emergency preparedness, health and safety, asset and organizational resilience, corporate governance and ethics measurements, team dynamics, recruiting ability, turnover, on-boarding practices, etc.
an organization's workplace and leadership actual and perceived support of health, wellness and well-being, collective health, wellness and well-being, occupational health and safety practices, respiratory infectious disease management, aggregated employee self rating for health, well-being, mental and physical health and resilience, policies regarding family leave, healthcare support, sleep support, vacations, professional growth and development, etc.

Organizational data may include any type of data related to or including information on organizational performance, organizational culture, organizational engagement, risk management within an organization, and/or an environment of care and support.

Data employed in the methods and systems described herein may also include environmental data related to or including information on metrics related to one or more environmental factors or conditions, such as one or more of the following:
performance testing on or other measurements of light, air quality, thermal comfort, acoustics, water quality, humidity, pollution, allergens, viruses, smell, etc.
perceived or actual satisfaction or comfort with indoor environmental quality, health, safety, aesthetics and design, ergonomics, inclusive design, design for sense of place, amenities, employee satisfaction with air, water (taste and access), scent, thermal comfort, light (natural and overall) and acoustic (overall and at a privacy level) settings, etc.

Environmental data may be any type of data that relates to or provides information on ambient environmental quality or occupant and/or market perceptions of indoor environmental quality.

Data employed in the methods and systems described herein may also include community data related to or including information on metrics related to communication and leadership, employee and stakeholder engagement, such as community engagement policies and initiatives, shared or collective spaces, collective values and practices, location and amenities, equity and historical acknowledgment, after house use of organizational facility for educational use, community use, personal and career development, etc. Community data may be any type of data that relates to or includes information on community and/or stakeholder engagement.

Data may also include global data related to or including information on metrics related to ESG related transparency and reporting, such as carbon reporting, compliance with or use of green building practices and standards, biodiversity impact reporting, ESG factors, etc. Global data may be any type of data that relates to or includes information on ESG transparency and reporting.

As part of a media and stakeholder analysis, an assessment may be done of organizations' current controversies with potentially negative impacts to environment, society, and employee health and well-being, sustainability-related, and other issues. It may be used as a system of “checks and balances” to ensure that organizations are upholding the policies and business standards that they report to their stakeholders, especially from a human and social capital management perspective.

In some embodiments, terms used herein may have or incorporate some or all of the following meanings, but are not limited to them:

Benchmarking result may include a comparison of one more of an organization's results to competitors and other peers in its industry, country, market size, income level, etc. and may help the organization better understand its competitive advantages and disadvantages, the drivers of its success or the causes of its lack of success, appropriateness of its strategies, how to improve its performance, etc. In some embodiments, a benchmarking result may relate to an index, fund or other financial product that can be measured or may be related to the tracking of the performance or progress of an organization, or between organizations, over time, regarding its policies, strategies, investments, human capital management, social capital management, etc.

ESG refers to environmental, social and governance which can be the three central factors in measuring the sustainability and societal impact of an investment in a company or business. Environmental factors may include things like climate impact and environmental challenges and opportunities, such as energy use, waste production & management, climate change, pollution, etc. Social factors may relate to how an organization treats employees and the community, and includes things like employee engagement programs, human rights policies, health and wellbeing initiatives, and employee and consumer protection. Governance factors may relate to how an organization operates and is run, which may include things like management structure, compensation, internal controls and accountability policies, shareholder rights, and more.

ESG related goal: a goal that may improve an environmental, social and governance related aspects of an organization, individual, product, service, manufacturing or other process, supply chain decision, sales and marketing decisions, customer and other distribution decisions, implemented policies, etc., which may enable an organization or individual to improve its operations, policies, strategies, approaches, etc. to improve sustainability, or otherwise become more socially responsible.

Health: A state of balance between physical, mental, and social states in the absence of illness. A component of well-being that may be comprised of both mental or psychological (e.g., stress and anxiety levels, coping mechanisms) and physical or physiological (e.g., blood pressure, cholesterol levels) indicators. Measured through a physical (e.g., annual physical) and psychological (e.g., mental health assessment) work-up. A person's health often changes over the long-term. Other measurements of health may include one or more of the following: blood pressure, BMI, cholesterol level, focus and concentration ability, glucose levels, heart rate, immune function, mental health, physical ability, sleep quality, stress and anxiety levels and coping mechanisms, urination and bowel movements, etc.

Human capital can be one or more of the skills, expertise, creativity, innovation, knowledge, experience and may represent the skills and expertise of one or more individuals in an organization. Human capital can be evaluated across areas including wellbeing, diversity, equity and inclusion (DEI), employee experience and operational excellence.

Human capital data is data related to economic and other value, rating, ranking, quality, etc. of an organization's employees that may influence or impact the organization's success, productivity, output, human capital, human capital management, economic benefits, worker performance, employee skills and talents, etc.

Human capital management may be or include a set of practices, policies, guidelines, objectives, etc. related to people resource management. These practices are focused on the organizational need to provide specific competencies and are implemented in categories including workforce acquisition, workforce management and workforce optimization. The applications that help to enable human capital management may include, but are not limited to, personnel administration, benefits administration, workforce planning, competency management, performance management, compensation planning and strategy, time and expense management, learning (e.g., education and training), recruitment (e.g., hiring, retention and recruitment), onboarding, reporting and analytics (e.g., workforce analytics), etc.

Human capital reporting: providing quantitative and/or qualitative information or other data on a range of measures (e.g., employee hiring, retention, turnover or employee engagement levels) to help identify which sort of human resources, employee or management practices may help improve an organization's success or performance, make a recommendation regarding them, etc.

Human capital trend(s) may be, include or otherwise relate to an organization's, country's, market segment's, etc. performance, success, or activity over time related to human capital and may be based on some or all of human capital data.

Index data may be created by an index provider such as S&P DJI to track the performance of a company or other organization, market, market segment, investment strategy, asset class, etc. Investors might not invest directly in an index, but they might invest in an index-linked product, such as ETFs. Market professionals may use index data as the basis for evaluating market behavior and trends. Indices help financial professionals and investors speak the same financial language. Financial analysts might use index data for company or sector attribution to determine what is driving individual stock prices and to make buy/sell recommendations. An analyst at a hedge fund may use real-time data to identify quantitative signals that have historically represented buy or sell opportunities. An index tracking healthcare costs or jobs might even inform a government official's views on policy. Strategy and thematic indices often are designed to mimic an investment strategy or to capture a specialized segment of the market. Thematic indices often represent market niches or specialized themes such as infrastructure, clean energy, or biotech stocks. Strategy indices often apply alternative methodologies or play on fundamentals.

Index data can be or include a list, collection, spreadsheet details, etc. of data, data sets, database entries, files, attributes, measurements, etc. that may be used to track or measure the performance of stocks, bonds or other financial or other assets, the owner or manager of such assets, etc. An index result is the outcome of analysis, assessment, or use or evaluation or use of the index data.

Insurance obligation(s) may include or refer to an organization's requirement to prepare, investigate, file, resolve, pay an actual, pending, or expected insurance claim. An insurance obligation also might relate to an organization's requirement to obtain or otherwise provide insurance coverage for certain people, activities, processes, products, services, or other activity or operation aspects of the organization.

Investment decision(s) by an organization may include acquiring, selling, reducing, increasing, terminating, etc. the organization's investment in, responsibility for, plans for or ownership of another organization or its assets; stocks, bonds, and other financial assets; exchange traded funds, land and other real estate; physical assets; land; data, intellectual property, and other intangible assets; tax advantaged expenditures or accounts; an new financial product or service; reduction of financial or other liabilities; inventory level; business or employee expansion or reduction plan; etc. In some embodiments, an investment decision may be contingent on, mutually exclusive to, or independent of another activity, result, prior investment, budget need or goal, business need or goal, etc.

Natural capital can include materials, travel, sustenance, health, well-being, etc. that supports organization and employee operations through the provision of materials and space to work, as well as deep inspirational and emotional values that drive what they do.

New financial product or service may include a new or different way for an individual or organization to: make a new financial investment; lend or borrow money or other asset (e.g., bonds, stock, loans, credit cards); create or use an exchange transfer fund; save or earn money; create or use an investment fund; obtain or provide credit; obtain or provide a warrant or option, etc.

As used herein, sustainable finance refers to the process of taking environmental, social and governance (ESG) considerations into account when making investment decisions in the financial sector, leading to more long-term investments in sustainable economic activities and projects.

Organizational policy: an organizational policy may include information regarding or otherwise relate to an organization's insurance; vacation or other benefit plan; compensation plan; email and internet usage; creation, use, modification, ownership and sharing of confidential information or intellectual property; network and computer security; employee hiring; onboarding, review and termination; travel; investment preferences and decisions; employee retirement or leave of absence; equity and diversity practices; ESG practices; workplace health and safety; ethics practices; remote work ability; compliance approach; employee conduct; antidiscrimination approach; marketing and sales guidelines and requirement; supply chain acquisition guidelines and requirements; etc.

Organizational report(s) may include written or electronic documents, submissions, postings, that the organization makes or provides, internally or externally, publicly or privately regarding the organization or some aspect of the organization (e.g., revenue, size, expansion or downsizing, human capital, expenses, business strategy, legal issues, investments or investment opportunities, etc.) its organizational strategy. Some reporting may be required by reporting standard, law, regulation or agreement that the organization is subject to, has agreed to provide, or must otherwise comply with.

Organizational strategy component(s) may include a goal, preference, obligation or other aspect of the organization's overall business, commercial, offering, product or service development, supply chain, employee, revenue, innovation, channel building, partnership building, growth or downsizing, monetization, sizing, course correction or pivot, investment, or other strategy, etc., or a portion thereof. A strategy component may deal with risks such as physical risks that may include outcomes from disruptive events like extreme weather that may have a direct impact on an organization, society and the economy. A strategy component also may deal with transition risks that may relate to societal and economic shifts, such as moving towards a less polluting, green economy. These paradigm shifts can have major impacts on various industries and sectors of an economy.

A reporting element may be or include a portion of a report or other document provided or under consideration by an organization, which may include information related to reporting or other standard, the format, content or presentation of such information, etc., or other information that an organization may include in any recurring or new reporting document. In some embodiments, a reporting element may be associated with or include some or all of a reporting standard or include organizational goals, strategies, structures, policies, leadership team, project level data, employee data, investment data, reference of various reporting standards, and other financial or non-financial information.

Reporting standard may be or include a requirement or other obligation that an organization has when providing an organizational report. This can include, for example, reporting whether or not the financial and other statements in the report meet generally accepted accounting principles (GAAP), the US Foreign Accounting Tax Compliance Act, the Common Reporting Standard, International Financial Reporting Standards, etc. In some embodiments, to help take into account thresholds, allocations, real world impacts, etc., regarding sustainability, a reporting standard may take into account, include, or otherwise relate to one or more of the following:
The U.S. SEC expanded disclosure requirements on human capital and supports ESG-related stakeholder proposals with large social policy impact;
Hong Kong Stock Exchange implemented mandatory disclosure requirements on eight social pillars;
The European Union proposed Social Taxonomy to set out global standards on social issues; and
Other standards, reporting or other disclosure, assessment or measurement requirements, etc. related to social capital, human capital, ESG policies or issues, sustainability, gaps or weaknesses in previously or currently used metrics or reporting standards, etc.

Social capital can include networks, communities, social norms, diversity of experience and opinion, etc. and can represent networks and relationships, values, understanding, etc. that facilitate cooperation within an organization.

Social capital data is data related to social capital data and other economic and other value, rating, ranking, quality, etc. of aspects of an organization's or individual's relationships and connections with each other, the nature and impact of such connections, ability of such connected organizations or individuals to collaborate, share resources, interact and coordinate; feelings of belong, social identity, trust, etc.; by organizations and individuals; etc.

Social capital management may be or include a set of practices, guidelines, objectives, policies, etc. related to social capital and may be based on social capital data. It may be directed to improving the effectiveness of social groups or members thereof, building a shared sense of purpose, identity, norms, values, etc.; improving cooperation, collaboration, sharing, interaction and coordination between parties; etc.

Social capital reporting: providing quantitative and/or qualitative information or other data on a range of measures to help identify which sort of social and other resources, interactions, collaborations, may help improve an organization's or individual's social capital or making a recommendation regarding such social capital.

A social capital trend may include or otherwise relate to an organization's or individual's performance, success, or activity over time related to social capital and may be based on some or all of social capital data.

Sustainability benchmarking provides a way to gather comparable information relative to other benchmarked entities, evaluate the sustainability performance of voluntary or mandatory standards, forecast potential business risks and opportunities, and demonstrate the positive impacts of an organization's sustainability programs. Competitive benchmarking can help determine whether or not an organization's sustainability strategies are effective, provide recommendations for closing potential gaps or weaknesses, and assess the business value to be gained by addressing those gaps or weaknesses. The benchmarking process also can provide a guidepost so that stakeholders, investors, customers, and industry peers have access to meaningful, standardized industry comparisons. Sustainability and ESG benchmarks can be used across all industries. For example, governments can use benchmarking programs to authorize sustainability standards for use in public procurement, such as the U.S. Environmental Protection Agency guidelines. Companies or businesses can use benchmarks to identify which standards or sustainability tools are appropriate or relevant to their operations. And nongovernmental organizations can rank the sustainability performance or progress of organizations as a way to incentivize improvement.

Well-being: A person's attitude or subjective perception towards their physical, mental, and social conditions. Often characterized through scales of life satisfaction, happiness, and prosperity. Although health factors can contribute to a person's well-being, other factors (e.g., life circumstances) contribute as well. May be measured through surveys. Well-being often changes over the long-term. Measurements of well-being may include measurements of accomplishment or achievement, happiness, health (subjective perception), job satisfaction, life satisfaction, relationship (e.g., friends, family, co-workers, romantic) satisfaction, resilience, etc.

Wellness: The process through which an individual becomes aware of, and makes choices towards, a healthy life and a higher state of well-being. An active undertaking. Could be measured through surveys establishing an individual's knowledge of and actions taken towards healthy lifestyle choices. Alternatively, over the short-term, wellness could be measured indirectly through improvements on health and well-being measures.

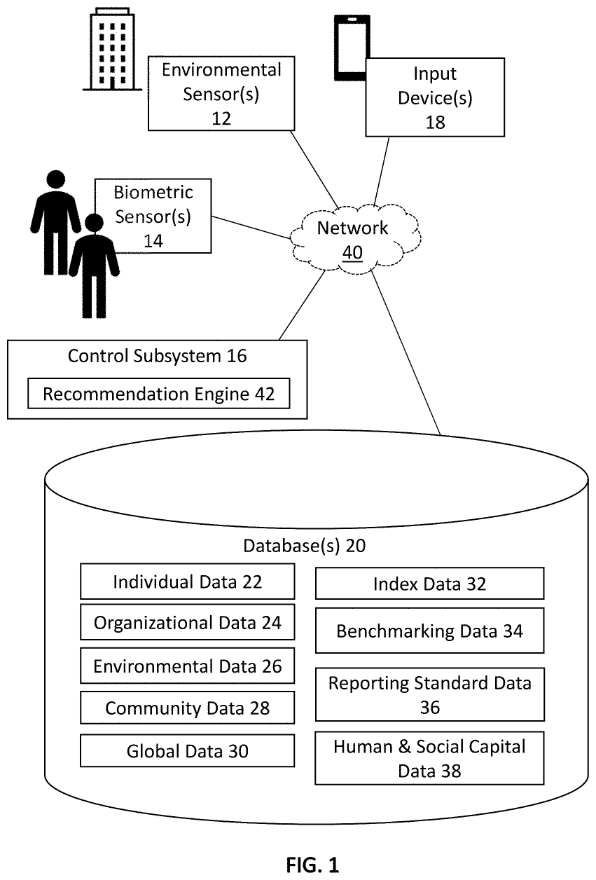

Turning to FIG. 1, an exemplary system 10 that may be used to determine or generate a recommendation is provided. The system may 10 include or have access to one or more input devices 18, one or more environmental sensors 12, one or more biometric sensors 14, a control subsystem 16, and one or more databases 20. It is contemplated that an organization may use the system 10 to perform one or more of the methods described herein.

The environmental sensors 12 may be or include one or more of any sensors operable to collect data on an indoor or outdoor environment. For example, the environmental sensors 12 may include light sensors, air pressure sensors, humidity sensors, air quality sensors, VOC sensors, carbon monoxide or carbon dioxide sensors, acoustic sensors, occupancy sensors, temperature sensors, or similar. Each of the environmental sensors 12 may be configured or operable to measure at least one parameter in an environment. In some aspects, an environment may be associated with an organization, an individual or group, a room or other indoor space, an outdoor space, a product or service, etc. The environmental sensors 12 may be configured to acquire one or more of the individual data 22, organizational data 24, environmental data 26, community data 28, and/or global data 30 as well as finance or financial product or service-related data, product or service related data, index data, etc.

The biometric sensors 14 may be any sensors operable to collect data on a measurable biological characteristic from an individual. For example, the biometric sensors 14 may include a temperature sensor operable to detect a body temperature, a scale operable to detect a body weight, a heart rate sensor operable to detect a heart rate, a blood oxygen sensor operable to detect a level of blood oxygen, a respiratory cycle sensor operable to detect at least one characteristic of a respiratory cycle, and an electroencephalography (EEG) sensor operable to detect at least one brainwave pattern. The biometric sensors 14 may also include one or more biometric sensors that measure blood pressure, activity levels, nutrient intake, electrocardiogram (EKG), perspiration, or other biometric parameters. The biometric sensors 14 may be configured to acquire one or more of the individual data 22, organizational data 24, environmental data 26, community data 28, and/or global data 30.

By one approach, the input devices 16 are configured to receive input from an individual. The input may include, but is not limited to, device settings, user preferences, component information, survey responses, selections, etc. The input devices 16 can take any suitable form such as panels installed in an indoor environment, a handheld mobile device, a computer, a kiosk, or the like. The input devices 16 may include a mouse, a touchscreen, a keyboard, a trackpad, a number pad, etc.

The control subsystem 18 may be operatively coupled to the environmental sensors 16 and/or the biometric sensors 14. The control subsystem 18 (also referred to as a controller or control circuit) may function as a computing device to perform the functions and methods described herein. It is contemplated that the control subsystem 16 may include a recommendation engine 42 or otherwise may be in communication with the recommendation engine 42. The control subsystem 16 may include one or more processors, input/output (I/O) devices, transceivers, and memory devices. The processors may include any suitable processing device such as a microprocessor, microcontroller, integrated circuit, logic device, or other suitable processing device. The processors may be used to execute or assist in executing the steps of the processes, methods, functionality and techniques described herein, and to control various communications, decisions, programs, content, listings, services, interfaces, logging, reporting, etc. Further, the one or more processors may access the memory devices, which may store instructions, code and the like that are implemented by the processors to implement intended functionality.

The control subsystem 16 may receive data from various components of the system 10. Further, the control circuit may transmit data to various components of the system 10. For example, the control subsystem 16 may receive data from the environmental sensors 12 and the biometric sensors 14. The control subsystem 16 may also receive data from the input devices 18. It is contemplated that the recommendation engine 42 may be integrated into or separate from the control subsystem 16.

The recommendation engine 42 is configured to perform one or more of the methods of determining a recommendation that are described herein. The recommendation engine 42 may be configured to analyze one or more type of data described herein, such as the individual data 22, organizational data 24, environmental data 26, community data 28, and/or global data 30 and/or the index data 32, the benchmarking data 34, the reporting standard data 36, and/or the human and social capital data 38 to determine a recommendation. In some aspects, the recommendation engine 42 is configured to identify relationships between one or more of the types of data described herein. In certain aspects, the recommendation engine 42 may be configured identify relationships individual data 22, organizational data 24, environmental data 26, community data 28, and/or global data 30 and data on an organization's investments and/or performance metrics. In other aspects, the recommendation engine 42 may be configured to determine, generate, or otherwise identify a recommendation for an organization, for example, based on the identified relationships.

In some aspects, the recommendation engine 42 may also be configured to determine trends in one or more of the types of data described herein. For example, the recommendation engine 42 may determine trends in the individual data 22, organizational data 24, environmental data 26, community data 28, and/or global data 30.

In some aspects, the recommendation engine 42 may be configured to generate scores, index results, reporting standards, or similar for an organization. The recommendation engine 42 may then determine, generate, or otherwise identify a recommendation for the organization based on the scores, index results, reporting standards, or similar. It is also contemplated that the recommendation engine 42 may determine relationships between the scores, index results, reporting standards, or similar and the individual data 22, organizational data 24, environmental data 26, community data 28, and/or global data 30.

In one example, the recommendation engine 42 may identify a relationship between the individual data 22, organizational data 24, environmental data 26, community data 28, and/or global data 30 associated with an organization and a score, index result, reporting standard, or similar for the organization. Then based on the score, index result, reporting standard, or similar, the recommendation engine 42 may be used to identify a recommendation for the organization. In some configurations, the recommendation may be based, at least in part, on the identified relationship(s) between the data. For example, if individual data 22 for an organization reflects low employee satisfaction or employee wellness, the recommendation engine 42 may assign a low score to the organization and may recommend that the organization implement a policy change that provides different health insurance, health incentive programs, smoking cessation programs, health screenings, etc. In another example, the recommendation engine 42 may receive organizational data 24 that is indicative of diversity, equity, and inclusion for an organization and assign a low index to the organization and, based on the low index, the recommendation engine 42 may identify a policy for improving diversity, equity, and inclusion.

In some approaches, the recommendation engine 42 may include, access or otherwise use one more machine learning algorithms. A machine learning algorithm may analyze various types of data described herein. For example, the machine learning algorithms may analyze the individual data 22, organizational data 24, environmental data 26, community data 28, and/or global data 30 and/or the index data 32, the benchmarking data 34, the reporting standard data 36, and/or the human and social capital data 38.

In some approaches, the machine learning algorithms may be trained to determine or otherwise identify a recommendation for an organization based on the individual data 22, organizational data 24, environmental data 26, community data 28, and/or global data 30. The machine learning algorithms may be trained using a training data set including historic individual data 22, organizational data 24, environmental data 26, community data 28, and/or global data 30 for an organization and historic policies, activities, initiatives, or similar implemented in the organization, such as policies known to improve ESG. In this manner, the machine learning algorithms maybe trained to identify recommended policies, activities, initiatives, or similar for an organization based on the individual data 22, organizational data 24, environmental data 26, community data 28, and/or global data 30 for that organization. Thus, the trained machine learning algorithm may receive individual data 22, organizational data 24, environmental data 26, community data 28, and/or global data 30 and determine a recommended policy, activity, initiative, or similar (i.e., a recommendation) based on the received individual data 22, organizational data 24, environmental data 26, community data 28, and/or global data 30 for the organization.

In another approach, the machine learning algorithms may be trained to determine a scores, index results, reporting standards, or similar for an organization based on the individual data 22, organizational data 24, environmental data 26, community data 28, and/or global data 30 for the organization. Further, the machine learning algorithms, may identify a recommendation for the organization based on the scores, index results, reporting standards, or similar. For example, the machine learning algorithms may be trained using a training data set including historic individual data 22, organizational data 24, environmental data 26, community data 28, and/or global data 30 for an organization and historic scores, index results, reporting standards, or similar. Thus, the trained machine learning algorithm may receive individual data 22, organizational data 24, environmental data 26, community data 28, and/or global data 30 and generate a score, index result, reporting standard, or similar based on the received individual data 22, organizational data 24, environmental data 26, community data 28, and/or global data 30 for the organization.

It is contemplated that the control circuit 18 may also generate an electronic report or scorecard for an organization that includes the score, index result, reporting standard, and/or the recommendation determined the recommendation engine 42.

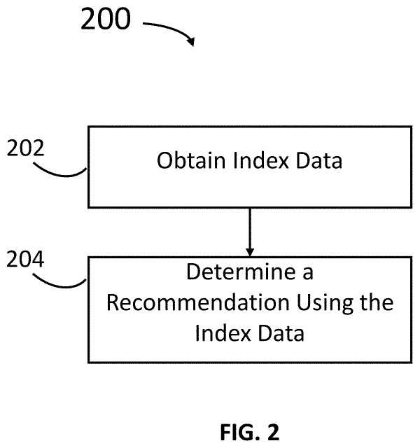

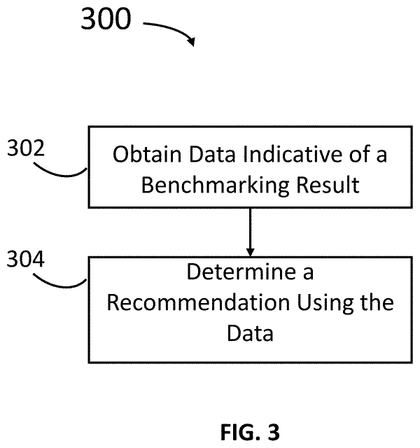

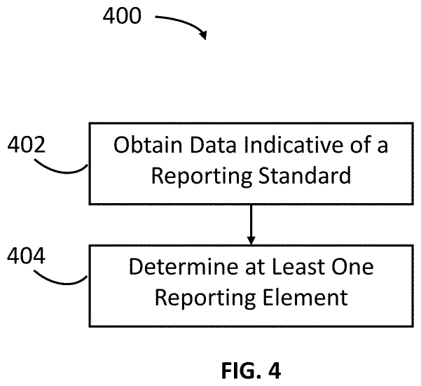

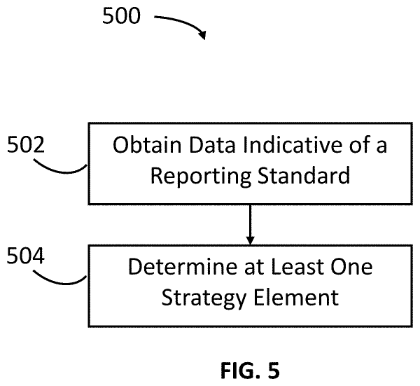

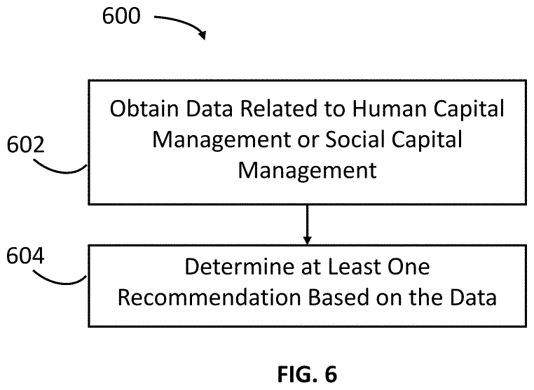

The system 10 may include or have access to one or more of the databases 20. The databases 20 may be local or remote and are in communication with the control subsystem 18 and, in some aspects, the environmental sensors 12 and/or the biometric sensors 14. The databases 20 may be stored, for example, on a server. The databases 20 may store some of all of the individual data 22, organizational data 24, environmental data 26, community data 28, and/or global data 30. Further, the databases 20 may store index data 32 (see e.g., FIG. 2), benchmarking data 34 (see e.g., FIG. 3), reporting standard data 36 (see e.g., FIGS. 4 and 5), and/or human and social data 38 (see e.g., FIGS. 6, 7, and 8). It is contemplated that one or more of the individual data 22, the organizational data 24, the environmental data 26, the community data 28, and/or the global data 30 may be included in or otherwise used to determine the index data 32, the benchmarking data 34, the reporting standard data 36, and/or the human and social data 38.

As illustrated in FIG. 1, some or all of the various components of the system 10 may communicate directly or indirectly, such as over one or more distributed communication networks, such as a network 40. For example, the network 40 may include LAN, WAN, Internet, cellular, Wi-Fi, and other such communication networks or combinations of two or more such networks.

In operation, the system 10 may receive, collect, or otherwise acquires or obtains data useful to generating or determining a recommendation for an engine. The system 10 may receive such data from one or more sensors or, in some approaches, from one or more surveys.

In some approaches, the system 10 receives, collects, or otherwise acquires the individual data 22, organizational data 24, environmental data 26, community data 28, and/or global data 30 from one or more sensors. For example, the control subsystem 18 may receive environmental data 22 from one or more of the environmental sensors 12. In another example, the control subsystem 18 may also receive individual data 24 from one or more of the biometric sensors 14.

In some approaches, the system 10 receives, collects, or otherwise acquires the individual data 22, organizational data 24, environmental data 26, community data 28, and/or global data 30 from one or more electronic surveys. For example, the control subsystem 18 may transmit an electronic survey and/or questions to one or more input devices 18 associated with an individual. In this manner, the control system 16 may then receive or collect data or information from the individual via responses entered via the input devices 18. In some approaches, the individual is associated with an organization for which a recommendation is to be generated using the methods described herein. The survey may prompt the individual to enter information related to an organization, environment, community, or otherwise and, in this manner, an individual may input information in the form of response. Responses may be used to generate one or more of individual data, organizational data, environmental data, community data, and global data. The survey and/or questions may relate to objective and/or subjective impressions of an individual about their mental or physical health, well-being, or performance. The survey and/or questions may also relate to an environment associated with the individual, such as a workplace. In some aspects, the survey and/or questions may relate to the culture, practices, performance, progress, or similar of an organization or community.

The recommendation engine 42 may analyze one or more of the individual data 22, organizational data 24, environmental data 26, community data 28, and/or global data 30. The recommendation engine 42 may then generate or otherwise determine a recommendation for an organization based on the analysis.

In some aspects, it is contemplated that the system 100 may also automatically implement one or more of the identified recommendations. For example, if the recommendation relates to an ESG goal or policy of the organization such as an environmental impact metric, the system 100 may automatically adjust a subsystem associated with a building environment or similar. Such a subsystem may be an air quality, water, lighting, heating, ventilation and air conditioning (HVAC) subsystem associated with a building environment, where the building is associated with or otherwise related to the organization. In one illustrative example, if the recommendation generated by the system 100 is to improve the organization's energy efficiency, the system 100 may adjust one or more operational parameters of a lighting or HVAC subsystem for a building associated with the organization to operate the lighting or HVAC subsystem in a more energy efficient manner. Thus, the system 100 may adjust the lighting or HVAC subsystem to implement the identified recommendation to improve the environmental impact metric and help to achieve the ESG goal.

Further, in other aspects, the system 100 may also transmit one or more electronic messages or reports or other signals or data to an individual(s) associated with the organization regarding the identified recommendations. For example, when the recommendation generated by the system 100 is to improve the organization's energy efficiency, the system 100 may transmit an electronic message to an individual associated with the organization reminding them to turn off lights or unplug equipment, or open shades to use natural sunlight to reduce energy usage as recommended and in furtherance of an ESG goal of the organization.

Now referring to FIG. 2, a method 200 is illustrated, some or all of which may be conducted by an organization. In step 202, index data may be obtained by an organization. The index data may include, but is not limited to, one or more of the following: organizational health and well-being initiatives data, employee health and well-being data, environmental safety data, sustainability strategy, social and environmental impact investments data, sustainable finance data and frameworks, employees engagement and productivity data, response to Covid-19 pandemic, climate change and physical risk mitigation strategies, diversity, equity and inclusion (DEI) policies, community engagement projects, etc., and might be based on some or all of the data types discussed above. In some embodiments, some or all of the index data may be generated and/or used by banks, fund companies, financial institutions and other organizations.

In some embodiments, step 202 may be conducted by an organization which collects, receives, accesses or develops some or all of the index data and analyzes some or all of the index data to create one or more index results. For example, an index result may be or include: aggregated scores or rating results from individual, environmental, organizational, community and global dimensions. In some aspects, the index results may provide an indicator or other measure of an organization's performance, progress, practices, or culture with respect to individual-scale, organizational-scale, environmental-scale, community scale, and/or global-scale metrics. And within each dimension, there may be themes that provide benchmarkable areas for tracking and represent target areas for achievement for organizations. Each theme may be supported by measurement metrics and questions for data collection, analysis and scoring. For example, see ESG Ratings Methodology, MSCI ESG Research LLC, November 2022, the contents of all of which are herein incorporated by reference for all purposes. See also, Environmental, Social and Governance Scores from Refinitiv®, February 2021, the contents of all of which are herein incorporated by reference for all purposes.

In some embodiments, index results may be created or otherwise obtained by banks, fund companies, other financial institutions and other organizations in step 202.

In step 204 a recommendation is determined based, at least in part, on some or all of the index data, which may include basing the recommendation on a portion of or all of an index result generated or otherwise created by analysis of the index data. In some embodiments, a recommendation may be based on some or all of the index data, analysis of some or all of the index data, some or all of an index result, or analysis based on an index result. In some embodiments, a recommendation may include or otherwise be related at least one policy of an organization; at least one obligation of an organization; at least one strategy component of an organization; at least one reporting activity of an organization; at least one content creation activity of an organization; at least one content distribution or other sharing activity of an organization; at least one feature of at least one product, or at least one feature or component of at least one product, provided, to be provided, or used or obtained by an organization; at least one feature of at least one service, or at least one feature of at least one service, provided, to be provided or used or obtained by an organization; at least one feature of at least one policy currently used or implemented, or under consideration for use, change or implementation by an organization; an insurance obligation of an organization, insurance coverage or policy for or an organization; an investment decision; a new financial product, a new sustainable finance instrument/framework, new uses of proceeds, new key performance indicators (KPIs) or new pricing mechanisms under existing financial instruments/frameworks, etc. In some embodiments a recommendation may include or be related to a policy or policy change currently associated with the organization or which may be implemented in the future by the organization, such as a health and safety policy, vacation policy, hiring policy, etc.

As further examples, in some embodiments, based on index data or one or more index results resulting from analysis or other use of the index data, financial analysts may use well-being/human capital index data for company or sector attribution to help inform what is driving individual stock prices and to make buy/sell recommendations, hedge fund analysts may use real-time well-being/human capital data to identify quantitative signals that have historically represented buy or sell opportunities, and investment funds and financial institutions may create new thematic investment product/portfolio that includes a focus on human capital and well-being.

In some embodiments, index data or index results may be generated, received or otherwise obtained and otherwise used by other index providers, such as Standard & Poor (S&P), MSCI, etc. In some embodiments, the index data or index results may be determined by a control circuit for example, by the recommendation engine 42 of the control subsystem 16. Based on the analysis of some or all of the index data, index results, etc., to determine at least one recommendation regarding the incorporation or use of well-being/human capital specific or holistic metrics and scores into their existing indices or create new index products. For example, S&P may consider incorporating the human capital index into its Corporate Sustainability Assessment which is the key methodology for S&P Dow Jones Sustainability Indices. In some embodiments, this might also take into account media, stakeholder and other analysis or assessment of an organizations' current or expected controversies with one or more potentially negative impacts to environment, society, employee health and well-being and other health, well-being, sustainability, etc., related issues. Thus, it might be used as a system or process of “checks and balances” to ensure that the organization is upholding the policies and business standards that it claims to their stakeholders, the media, and others, especially from a human and social capital management perspective. For example, see the S&P Global Media & Stakeholder Analysis —Methodology Guidebook, Corporate Sustainability Assessment, S&P Global Inc., 2022, the contents of all of which are herein incorporated by reference for all purposes. See also CSA Companion 2022, S&P Global Corporate Sustainability Assessment, S&P Global Inc. (2021), the contents of which are incorporated by reference for all purposes.

In some embodiments, the step 202 may include receiving one or more signals that contains or is otherwise indicative of some or all of the index data, accessing one or more databases, devices or other sources that contain some or all of the index data, requesting or sending a signal requesting some or all of the index data, etc.

In some embodiments, the method 200 also may include using some or all of the index data obtained in step 202 to create one or more index results and then using the index result(s) in step 204 to create a recommendation.

In some embodiments, the method 200 also may include additional steps such as sending a signal indicative of some or all of a recommendation, some or all the index data, information regarding the organization, one or more source(s) of some or all of the index data, receiving a signal indicative of receipt or implementation of a recommendation, conducting market analysis based at least in part on the data, etc.

Now referring to FIG. 3, a method 300 is illustrated, some or all of which may be conducted by an organization. In step 302, data may be obtained by an organization that is indicative of a benchmarking result. The data may include, but is not limited to, one or more of the data types described above or otherwise be based on some or all of the data types discussed above.

In some embodiments, step 302 may be conducted by an organization which collects, receives, accesses or develops some or all of the data and analyzes some or all of the data to create or identify one or more benchmarking results. For example, a benchmarking result may be or include an overview of an organizations' performance or progress in human and social capital compared with its peers in the same industry or the average of organizations from other industries. The overview includes the scoring/rating results comparison of each key dimension, theme and questions/metrics relating to human and social capital performance or progress. For each organization, the final score or rating is based on the aggregated scores or rating results from individual, environmental, organizational, community and global dimensions. And within each dimension, there are themes that provide benchmarkable areas for tracking and represent target areas for achievement for organizations. Each theme is supported by measurement metrics and questions for data collection, analysis and scoring.

In some embodiments, a benchmarking result may be created or identified by leveraging index, scoring or other data as described above and help to generate a comparison of results among particular organizations/users or across industries. For example, see GRESB 2021 Real Estate Assessment Reference Guide, the contents of all of which are herein incorporated by reference for all purposes.

In step 304 a recommendation is determined based, at least in part, on some or all of the data, which may include basing the recommendation on a portion of or all of a benchmarking result generated or otherwise created by analysis of the data obtained in step 302. For example, analysis or use of a benchmarking result may inform an organization of its performance or progress in human and social capital management in comparison with the performance or progress of the peers within its industry, and/or the average of users from other industries. Based on the data, one or more benchmarking results, and one or more recommendations, an organization may be able to incorporate them into its annual ESG and sustainability reporting, and inform its business decision making on key human and social capital management, HR policies, corporate well-being initiatives, etc.

The recommendation provided in step 304 may include or be similar to one or more of the recommendations described previously above.

In some embodiments, the step 302 may include receiving one or more signals that contains or is otherwise indicative of some or all of the data, accessing one or more databases, devices or other sources that contain some or all of the data, requesting or sending a signal requesting some or all of the data, etc.

In some embodiments, the method 300 also may include using some or all of the data obtained in step 302 to create one or more benchmarking results and then using the benchmarking result(s) in step 304 to create a recommendation.

In some embodiments, the method 300 also may include additional steps such as sending a signal indicative of some or all of a recommendation, some or all the data, information regarding the organization, one or more source(s) of some or all of the data or benchmarking result, receiving a signal indicative of receipt or implementation of a recommendation, conducting market analysis based at least in part on the data, etc.

Now referring to FIG. 4, a method 400 is illustrated, some or all of which may be conducted by an organization. In step 402, data may be obtained by an organization that is indicative of a reporting standard. The data may include, but is not limited to, one or more of the data types described above or otherwise be based on some or all of the data types discussed above.

In some embodiments, the step 402 may be conducted by an organization which collects, receives, accesses or develops some or all of the data and analyzes some or all of the data to create or identify one or more reporting standards.

In step 404 a reporting element is determined based, at least in part, on some or all of the data, or otherwise created by analysis of the data obtained in step 402. In some embodiments, a reporting element may be or include part of a reporting document.

In some embodiments, analysis or use of a reporting standard or a reporting element may help inform an organization of health, well-being, human and social capital performance dimensions, themes and metrics for strategy setting, reporting and storytelling.

Based on the data, one or more reporting standards, or one or more reporting elements, an organization may be able to incorporate them into its annual ESG and sustainability reporting, sustainable finance frameworks, and inform its business decision making on key human and social capital management, HR policies, corporate well-being initiatives, community engagement, and long-term sustainability vision and goals, etc.

In some embodiments, the step 402 may include receiving one or more signals that contains or is otherwise indicative of some or all of the data, accessing one or more databases, devices or other sources that contain some or all of the data, requesting or sending a signal requesting some or all of the data, conducting market analysis based at least in part on the data etc.

In some embodiments, the method 400 also may include using some or all of the data obtained in step 302 to create one or more reporting standards and then using the reporting elements in step 304 to create the reporting elements.

In some embodiments, the method 400 also may include additional steps such as sending a signal indicative of some or all of the reporting standard or reporting element(s), some or all the data, information regarding the organization, one or more source(s) of some or all of the data or reporting standard, receiving a signal indicative of receipt or implementation of the reporting element, implementing the reporting element, conducting market analysis based at least in part on the data, etc.

Now referring to FIG. 5, a method 500 is illustrated, some or all of which may be conducted by an organization. The method 500 includes the step 402 previously discussed above, wherein, data may be obtained by an organization that is indicative of a reporting standard. The data may include, but is not limited to, one or more of the data types described above or otherwise be based on some or all of the data types discussed above.

In step 504 a strategy element is determined based, at least in part, on some or all of the data, or otherwise created by analysis of the data obtained in step 402. In some embodiments, a strategy element may be or include some or all of a strategy component or other business, commercial, financial, partnership, manufacturing, distribution, marketing, procurement, etc. strategy related aspect, activity, policy, etc. of an organization currently being implemented, under consideration for implementation, change or removal, etc.

For example, analysis or use of a reporting standard or a reporting element may inform an organization of one or more health, well-being, human and social capital performance dimensions, themes and metrics for strategy setting, reporting and storytelling.

Based on the data, one or more reporting standards, one or more reporting elements, one or more strategy elements, an organization may be able to incorporate them into its annual ESG and sustainability reporting to help inform its business decision making on key human and social capital management, HR policies, diversity, equity and inclusion initiatives, corporate well-being initiatives, community engagement, and long-term sustainability vision and goals, etc.

In some embodiments, the step 502 may include receiving one or more signals that contains or is otherwise indicative of some or all of the data, accessing one or more databases, devices or other sources that contain some or all of the data, requesting or sending a signal requesting some or all of the data, etc.

In some embodiments, the method 500 also may include using some or all of the data obtained in step 502 to create one or more reporting standards and then using the reporting elements in step 504 to create the strategy element.

In some embodiments, the method 500 also may include additional steps such as sending a signal indicative of some or all of the reporting standard or strategy element(s), some or all the data, information regarding the organization, one or more source(s) of some or all of the data or reporting standard, receiving a signal indicative of receipt or implementation of the strategy element, implementing the strategy element, conducting market analysis based at least in part on the data, etc.

Now referring to FIG. 6, a method 600 is illustrated, some or all of which may be conducted by an organization. In step 602, data may be obtained by an organization that is indicative of or otherwise relates to at least one of human capital management and social capital management. The data may include, but is not limited to, one or more of the data types described above or otherwise be based on some or all of the data types discussed above.

As previously discussed above human capital management may relate to a set of or one or more practices, policies, tools, etc. related to people resource management. These practices, policies, tools, etc. may be focused on one or more organizational needs in order to provide one or more specific competencies and may be implemented in categories including workforce acquisition, workforce management and workforce optimization. The applications that help to enable human capital management include personnel administration, benefits administration, workforce planning, competency management, performance management, compensation planning and strategy, time and expense management, learning (e.g., education and training), recruitment (hiring, retention, and recruitment), onboarding, reporting and analytics (e.g., workforce analytics), etc.

As previously discussed above, social capital management may relate to a set of one or more practices, policies, tools, etc., related to personal relationships, social network support, civic engagement, community engagement, diversity, equity and inclusion, trust, cooperative norms, etc.

In some embodiments, the step 602 may be conducted by an organization which collects, receives, accesses or develops some or all of the data and analyzes some or all of the data to create or identify one or more recommendations.

In step 604 a recommendation is determined based, at least in part, on some or all of the data, or otherwise created by analysis of the data obtained in step 602.

For example, analysis or use of some or all of the data obtained in step 602 reporting standard may inform an organization of its performance in human and social capital management in comparison with the performance of the peers within its industry, and/or the average of users from other industries.

Based on the data, one or more recommendations, etc., an organization may be able to incorporate them into or use them as the basis for its annual ESG, CSR, sustainable finance and sustainability reporting, and inform its business decision making on key human and social capital management, HR policies, corporate well-being initiatives, sustainable financing and investment activities, etc.

In some embodiments, the step 602 may include receiving one or more signals that contains or is otherwise indicative of some or all of the data, accessing one or more databases, devices or other sources that contain some or all of the data, requesting or sending a signal requesting some or all of the data, etc.

In some embodiments, the method 600 also may include additional steps such as sending a signal indicative of some or all of the recommendation(s), some or all the data, information regarding the organization, one or more source(s) of some or all of the data, receiving a signal indicative of receipt or implementation of a recommendation, implementing a recommendation, conducting market analysis based at least in part on the data, etc.

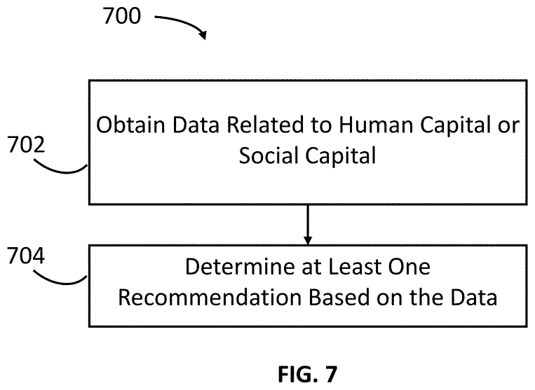

Now referring to FIG. 7, a method 700 is illustrated, some or all of which may be conducted by an organization. In step 702, data may be obtained by an organization that is indicative of or otherwise relates to at least one of human capital data and social capital data. The data may include, but is not limited to, one or more of the data types described above or otherwise be based on some or all of the data types discussed above.

As previously discussed above human capital data may relate to a set of or one or more practices, policies, tools, etc. related to people resource management. These practices, policies, tools, etc. may be focused on one or more organizational needs in order to provide one or more specific competencies and may be implemented in categories including workforce acquisition, workforce management and workforce optimization. The applications that help to enable human capital management include personnel administration, benefits administration, workforce planning, competency management, performance management, compensation planning and strategy, time and expense management, learning (e.g., education and training), recruitment (hiring, retention, and recruitment), onboarding, reporting and analytics (e.g., workforce analytics), etc.

In some embodiments, the data obtained in the step 702 may include one or more of the following: receiving, accessing, acquiring, determining, collecting data indicative of at least a portion of human capital data; and receiving, accessing, acquiring, determining, collecting data indicative of at least a portion of social capital data.

In some embodiments, the step 702 may be conducted by an organization which collects, receives, accesses or develops some or all of the data and analyzes some or all of the data to create or identify one or more recommendations.

In step 704 a recommendation is determined based, at least in part, on some or all of the data, or otherwise created by analysis of the data obtained in step 702. In some embodiments a recommendation may relate to one or more of the following: at least one policy of the organization, at least one insurance obligation of the organization, insurance coverage of the organization, etc. In some embodiments, an organization may provide health services, medical services, health or medical insurance related services, etc.

For example, analysis or use of some or all of the data obtained in step 702 reporting standard may inform an organization of its performance in human and social capital management in comparison with the performance of the peers within its industry, and/or the average of users from other industries.

Based on the data, one or more recommendations, etc., an organization may be able to [incorporate them into or use them as the basis for its annual ESG and sustainability reporting, and inform its business decision making on key human and social capital management, HR policies, corporate well-being initiatives, etc.

In some embodiments, the step 602 may include receiving one or more signals that contains or is otherwise indicative of some or all of the data, accessing one or more databases, devices or other sources that contain some or all of the data, requesting or sending a signal requesting some or all of the data, etc.

In some embodiments, the method 700 also may include additional steps such as sending a signal indicative of some or all of the recommendation(s), some or all the data, information regarding the organization, one or more source(s) of some or all of the data, receiving a signal indicative of receipt or implementation of a recommendation, implementing a recommendation, conducting market analysis based at least in part on the data etc.

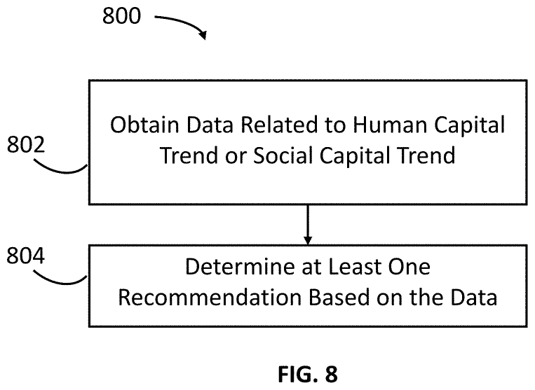

Now referring to FIG. 8, a method 800 is illustrated, some or all of which may be conducted by an organization. In step 802, data may be obtained by an organization that is indicative of or otherwise relates to at least one of human capital trends and social capital trends. The data may include, but is not limited to, one or more of the data types described above or otherwise be based on some or all of the data types discussed above.

A human capital trend may relate to a set of or one or more practices, policies, tools, etc. related to people resource management. These practices, policies, tools, etc. may be focused on one or more organizational needs in order to provide one or more specific competencies and may be implemented in categories including workforce acquisition, workforce management and workforce optimization. The applications that help to enable human capital management include personnel administration, benefits administration, workforce planning, competency management, performance management, compensation planning and strategy, time and expense management, learning (e.g., education and training), recruitment (hiring, retention, and recruitment), onboarding, reporting and analytics (e.g., workforce analytics), etc.

In some embodiments, the data obtained in the step 802 may include one or more of the following: receiving, accessing, acquiring, determining, collecting data indicative of at least a portion of a human capital trend; and receiving, accessing, acquiring, determining, collecting data indicative of at least a portion of a social capital trend.

In some embodiments, the step 802 may be conducted by an organization which collects, receives, accesses or develops some or all of the data and analyzes some or all of the data to create or identify one or more recommendations.

In step 804 a recommendation is determined based, at least in part, on some or all of the data, or otherwise created by analysis of the data obtained in step 802. In some embodiments a recommendation may relate to one or more of the following: at least one policy of the organization, at least one insurance obligation of the organization, insurance coverage of the organization, a strategy component of an organization, at least one policy of an organization, at least one obligation of an organization, at least one reporting activity of an organization; at least one content creation activity of an organization; at least one content sharing activity of an organization; at least one strategy component of an organization; at least one feature of at least one product provided by an organization; at least one feature of at least one service provided by an organization; at least one feature of at least one product used by an organization; at least one feature of at least one service used by an organization; at least one feature of at least one policy implemented by an organization; etc. In some embodiments, an organization may provide health services, medical services, health or medical insurance related services, et.

For example, analysis or use of some or all of the data obtained in step 802 reporting standard may inform an organization of its performance in human and social capital management in comparison with the performance of the peers within its industry, and/or the average of users from other industries.

Based on the data, one or more recommendations, etc., an organization may be able to incorporate them into or use them as the basis for its annual ESG and sustainability reporting, and inform its business decision making on key human and social capital management, HR policies, corporate well-being initiatives, etc.

In some embodiments, the step 802 may include receiving one or more signals that contains or is otherwise indicative of some or all of the data, accessing one or more databases, devices or other sources that contain some or all of the data, requesting or sending a signal requesting some or all of the data, etc.

In some embodiments, the method 800 also may include additional steps such as sending a signal indicative of some or all of the recommendation(s), some or all the data, information regarding the organization, one or more source(s) of some or all of the data, receiving a signal indicative of receipt or implementation of a recommendation, implementing a recommendation, conducting market analysis based at least in part on the data, etc.

In some embodiments, one or more steps of a method disclosed herein, or portions thereof may, be implemented by one or more devices or systems, such as a computer, server, smart phone or other smart device, tablet, automation system or device, other smart device, etc., a software platform, or an application or other software operating on such one or more of such devices or systems.

In some embodiments, a system to conduct one or more of the methods described herein, or steps thereof, may include or have access to a control subsystem or other subsystem that includes at least one processor and at least one non-transitory processor-readable medium that stores at least one of processor-executable instructions or data. A system may further include one or more wired or wireless input devices. The input devices may be communicatively coupled to the central control circuit. In some embodiments, an input device in the system may include a display and also may include user actuatable controls (e.g., user selectable icons displayed on touch screen, keys, buttons). In some approaches, a mobile or handheld device may serve as the input device and may include a display (e.g., LCD) to display information to select parameters or programs to execute to control one or more components of the system or the methods. The mobile or handheld device may execute a downloaded customized application or “APP” that communicatively interfaces via a wireless protocol (e.g., IEEE 802.11, BLUETOOTH®, WI-FI®, Zigbee, Z-Wave, LTE). One or more components of the system may communicate directly or indirectly, such as over one or more distributed communication networks, which may include or access LAN, WAN, Internet, Cellular, Wi-Fi, private, public and other such communication networks or combinations of two or more such networks. In some embodiments, a system or device may include a database or other information, or have access to one or more databases or other information.

In some embodiments, a control other subsystem may take the form of a programmed computer or other processor-based system or device. For example, a control subsystem may take the form of a conventional mainframe computer, mini-computer, workstation computer, personal computer (desktop or laptop), handheld computer, or other smart device.

A control or other subsystem may include one or more processing units, non-transitory system memories and a system bus that couples various system components including the system memory to one or more processing unit. A processing unit(s) may be or include any logic processing unit, such as one or more central processing units (CPUs), digital signal processors (DSPs), application-specific integrated circuits (ASICs), field programmable gate arrays (FPGAs), programmable logic controllers (PLCs), etc. A system bus may use, include or access any known bus structures or architectures, including a memory bus with memory controller, a peripheral bus, and a local bus. A system memory may include or have access to non-transitory Flash or read-only memory (ROM) and non-transitory random access memory (“RAM”). A basic input/output system (BIOS), which can form part of the ROM or RAM, may include or contain one or more basic routines that help transfer information between elements within the control or other subsystem, such as during start-up.

The control or other subsystem may include a hard disk drive for reading from and writing to a hard disk, an optical disk drive for reading from and writing to removable optical disks, and/or a magnetic disk drive for reading from and writing to magnetic disks. The optical disk can be or include a CD/DVD-ROM, while the magnetic disk can be or include a magnetic floppy disk or diskette. The hard disk drive, optical disk drive and magnetic disk drive may communicate with a processing unit via a system bus. The hard disk drive, optical disk drive and magnetic disk drive also may include interfaces or controllers (not shown) coupled between such drives and a system bus, as is known by those skilled in the relevant art. The drives and their associated computer-readable storage media may provide nonvolatile and non-transitory storage of computer readable instructions, data structures, program engines and other data. Those skilled in the relevant art will appreciate that other types of computer- or processor-readable storage media that can store data accessible by a computer may be employed, such as magnetic cassettes, flash memory, digital video disks (“DVD”), Bernoulli cartridges, RAMs, ROMs, smart cards, etc.

Program engines can be stored in the system memory, such as an operating system, one or more application programs, other programs or engines and program data. Application programs may include instructions that cause a processor to automatically generate signals to control various of one or more other subsystems. An application program may include instructions that cause a processor to automatically receive input and/or display output via various user operable input/output (I/O) devices, controls, panels or kiosks or television, smart devices, etc.

Other program engines may include instructions for handling security such as password or other access protection and communications encryption. A system memory may also include communications programs, for example, a server for permitting the control or other subsystem to provide services and exchange data with other subsystems or computer systems or devices via the Internet, corporate intranets, extranets, or other networks (e.g., LANs, WANs), as well as other server applications on server computing systems or devices. A server may be markup language based, such as Hypertext Markup Language (HTML), Extensible Markup Language (XML) or Wireless Markup Language (WML), and may operate with markup languages that uses syntactically delimited characters added to the data of a document to represent the structure of the document.

U.S. Patent Publication Nos. 2022/0261819, 2022/0244296, 2022/0027810, 2021/0224843, 2021/0081965, 2020/0320633, 2020/0200416, 2020/0193351, 2020/0174984, 2020/0160442, 2019/0362427, 2019/0244296, 2018/0189803, 2018/0075393, 2016/0117774, 2014/0297558, 2013/0346247, 2013/0204805, 2013/0132233, 2012/0316916, 2012/0296845, 2011/0060612, 2011/0047086, 2010/0274603, 2009/0171722, 2009/0106317, 2009/0089126, 2008/0255899, 2006/0265230, 2006/0100897, 2005/0021389, and 2003/0018487, and U.S. Pat. Nos. 11,449,673, 11,338,107, 11,188,983, 10,923,226, 10,902,520, 10,346,920, 9,715,242, 8,781,884, 8,731,992, 8,671,040, 8,352,346, 7,197,397, and 6,490,565, the entire disclosures of all of which, except for any disclaimers, disavowals, and inconsistencies, are incorporated herein by reference in their entirety for all purposes.

International Patent Publication No. WO2023/273295, WO2021/1004550, and WO2019/103183, the entire disclosures all of which, except for any disclaimers, disavowals, and inconsistencies, are incorporated herein by reference in their entirety for all purposes.

The following articles and other documents, the entire disclosures of which, except for any disclaimers, disavowals, and inconsistencies, are incorporated herein by reference in their entirety for all purposes.
MSCI ESG Ratings Methodology November 2020.
Environmental, Social and Governance Scores from Refinitiv, February 2021.
S&P Media & Stakeholder Analysis—Methodology Guidebook Corporate Sustainability Assessment 2021.
CSA Companion 2021 Corporate Sustainability Assessment.
GRESB 2021 Real Estate Assessment Reference Guide.
McCarthy, Kelly et al, IRIS+ Thematic Taxonomy (2021).
IRIS+ and the Five Dimensions of Impact, Global Impact Investing Network (2019).
Sisson P. As risks of climate change rise, investors seek greener buildings. New York Times. Nov. 23, 2021.
Hong Kong Exchange and Clearing Limited. Exchange publishes corporate governance and ESG (climate disclosures) Guidance. Hong Kong Exchange and Clearing, Limited. Jan. 21, 2022. Updated Nov. 5, 2021.
Glazerman G. Spotlight on Human Capital Has Investors' Attention. Value Reporting Foundation, SASB Standards. Jan. 21, 2022. Updated Jun. 10, 2019.
Social and Human Capital Coalition. Social and Human Capital Protocol. Updated February 2019.
EY Coalition for Inclusive Capitalism. The Embankment Project for Inclusive Capitalism Report.
World Economic Forum. Human Capital as an Asset: An Accounting Framework to Reset the Value of Talent in the New World of Work.
OECD. Measuring Well-being and Progress: Well-being Research. OECD. Dec. 23, 2021.
O'Connor C, Labowitz S. Putting the “S” in ESG: Measuring Human Rights Performance for Investors. 2017.
Meister J. The future of work is employee well-being. website. Forbes. Nov. 23, 2021.
Grossmeier J, Fabius R, Flynn J P, et al. Linking Workplace Health Promotion Best Practices and Organizational Financial Performance: Tracking Market Performance of Companies With Highest Scores on the HERO Scorecard. Journal of Occupational and Environmental Medicine. 2016; 58(1):16-23.
World Economic Forum. Measuring Stakeholder Capitalism Towards Common Metrics and Consistent Reporting of Sustainable Value Creation.
EY, Capitalism Cfl. The Embankment Project for Inclusive Capitalism Report.
Preber B. ESG investing needs standards to prevent fraud and greenwashing. website. Fortune. Nov. 23, 2021.
Siegel Bernard T. The Biden Administration proposes reversing Trump-era rules on socially conscious investing. New York Times. Nov. 23, 2021.
Holzer, J. M. et al., Evaluating transdisciplinary science to open research-implementation spaces in European social-ecological systems, Biological Conservation 238 (2019) 108228.
Stone-Jovicich S, Goldstein B E, Brown K, Plummer R, Olsson P. Expanding the contribution of the social sciences to social-ecological resilience research. Ecology and Society. 2018; 23(1)41.
Buizer M, Ruthrof K, Moore S A, Veneklaas E J, Hardy G, Baudains C. A Critical Evaluation of Interventions to Progress Transdisciplinary Research. Society and Natural Resources: An International Journal. 2015; 28:670-681.
Grose M J. Gaps and futures in working between ecology and design for constructed ecologies. Landscape and Urban Planning. December 2014; 132(0):69-78.
McLeroy K R, Bibeau D, Steckler A, Glanz K. An ecological perspective on health promotion programs. Health education quarterly. 1988; 15(4):351-377.

In some aspects, a method for determining a recommendation for an organization comprises the steps of: obtaining data indicative of at least one benchmarking result; and determining a recommendation based, at least in part, on the data.

In some aspects, the recommendation relates to at least one strategy component of the organization.

In some aspects, the method further comprises implementing at least a portion of the recommendation.

In some aspects, the method further comprises sending a signal indicative, at least in part, of at least a portion of the recommendation.

In some aspects, the recommendation relates to at least one ESG goal of the organization or to at least one policy of the organization.

In some aspects, a method for modifying an organization's performance, comprises the steps of: obtaining data related to at least one reporting standard; determining at least one strategy element based, at least in part, on the at least one reporting standard; and implementing at least a portion of the strategy element.

In some aspects, a method for modifying an organization's reporting, comprises the steps of: obtaining data related to at least one reporting standard; determining at least one reporting element based, at least in part, on the at least one reporting standard; and implementing at least a portion of the reporting element.

In some aspects, a method for determining a recommendation for an organization, comprises the steps of: obtaining data related to at least one of human capital management and social capital management; determining at least one recommendation based, at least in part, on the data; and implementing at least a portion of the at least one recommendation.

In some aspects, a method for determining a recommendation for an organization, comprises the steps of: obtaining data related to at least one of human capital data and social capital data; determining at least one recommendation based, at least in part, on the data; and implementing at least a portion of the at least one recommendation.

In some aspects, the at least one recommendation relates to at least one of the following: at least one policy of the organization; at least one insurance obligation of the organization; insurance coverage of the organization; and at least one reporting element associated with the organization.

In some aspects, the organization provides health services or health insurance related services.

In some aspects, obtaining data related to at least one of human capital data and social capital data includes at least one of the following: receiving data indicative of at least a portion of the human capital data; receiving data indicative of at least a portion of the social capital data; accessing data indicative of at least a portion of the human capital data; accessing data indicative of at least a portion of the social capital data; collecting at least a portion of the human capital data; collecting at least a portion of the social capital data; determining at least a portion of the human capital data; or determining at least a portion of the social capital data.

In some aspects, a method for determining a recommendation for an organization, comprises the steps of: obtaining data related to at least one of human capital trend and social capital trend; determining at least one recommendation based, at least in part, on the data; and implementing at least a portion of the at least one recommendation. 28 The method of clause 27, further comprising conducting market analysis based, at least in part, on the data.

In some aspects, the at least one recommendation relates to at least one of the following: at least one policy of the organization; at least one obligation of the organization; at least one strategy component of the organization; at least one reporting activity of the organization; at least one content creation activity of the organization; at least one content sharing activity of the organization; at least one strategy component of the organization; at least one feature of at least one product provided by the organization; at least one feature of at least one service provided by the organization; at least one feature of at least one product used by the organization; at least one feature of at least one service used by the organization; at least one feature of at least one policy implemented by the organization.

In general, in the following claims, the terms used should not be construed to limit the claims to the specific embodiments disclosed in the specification and the claims, but they should be construed to include all possible embodiments along with the full scope of equivalents to which such claims are entitled. Accordingly, the claims are not limited by the disclosure.

What is claimed is:

1. A method for providing a recommendation, the method including:
by a control circuit:
receiving index data indicative of performance of an organization in an individual dimension, an environmental dimension, an organizational dimension, a community dimension, and a global dimension;
assigning an index result to the organization based on the index data, the index result providing an aggregated score for the organization for the individual dimension, the environmental dimension, the organizational dimension, the community dimension, and the global dimension; and
automatically determining at least one recommendation based, at least in part, on the index data, the index result, or a combination thereof.

2. The method of claim 1, wherein at least a portion of the index data is received directly or indirectly from at least one sensor associated with an individual associated with the organization, or with an environment associated with the organization.

3. The method of claim 1, further comprising receiving a signal that contains at least a portion of the index data.

4. The method of claim 1, further comprising sending a signal indicative, at least in part, of at least a portion of the recommendation.

5. The method of claim 1, wherein the method further includes transmitting at least one electronic survey to at least one individual associated with the organization and receiving at least some of the index data in response to the at least one electronic survey.

6. The method of claim 1, wherein the at least one recommendation relates to at least one of the following:
at least one policy of an organization;
at least one obligation of an organization;
a business strategy of an organization;
insurance coverage of an organization;
an ESG goal of an organization;
a human capital related goal of an organization;
a social capital related goal of an organization;
a new financial product;
a new investment;
at least one strategy component of the organization;
at least one reporting activity of the organization;
at least one content creation activity of an organization;
at least one content sharing activity of an organization;
at least one strategy component of the organization;
at least one feature of at least one product provided by an organization;
at least one feature of at least one service provided by an organization;
at least one feature of at least one product used by an organization;
at least one feature of at least one service used by an organization; or
at least one feature of at least one policy implemented by an organization.

7. A method for determining a recommendation for an organization, the method comprising:
by a control circuit:
obtaining data related to at least one of human capital data and social capital data for an organization, the data including at least one of:
individual data indicative of health or wellbeing, thriving, performance, motivation, or effectiveness of individual associated with the organization;
organizational data indicative of organization performance, organizational culture, organizational engagement, risk management, or an environment of care for the organization;
environmental data indicative of environmental quality or perceptions of environmental quality associated with the organization;
community data indicative of community engagement or stakeholder engagement for the organization; or
global indicative of environmental, social, and global transparency or reporting for the organization;
automatically determining at least one recommendation based, at least in part, on the data; and
implementing at least a portion of the at least one recommendation.

8. The method of claim 7, wherein the at least one recommendation relates to at least one of the following:
at least one policy of the organization;
at least one insurance obligation of the organization;
insurance coverage of the organization; or
at least one reporting element associated with the organization.

9. The method of claim 7, wherein the organization provides health services or health insurance related services.

10. The method of claim 7 further comprising:
automatically determining at least one reporting element for the organization based on the data, and
implementing at least a portion of the at least one reporting element.

11. The method of claim 7, wherein obtaining data related to at least one of human capital data and social capital data includes at least one of the following:
receiving data indicative of at least a portion of the human capital data;
receiving data indicative of at least a portion of the social capital data;
accessing data indicative of at least a portion of the human capital data;
accessing data indicative of at least a portion of the social capital data;
collecting at least a portion of the human capital data,
collecting at least a portion of the social capital data;
determining at least a portion of the human capital data; and
determining at least a portion of the social capital data.

12. The method of claim 7, wherein the method further includes transmitting at least one electronic survey to at least one individual associated with the organization and receiving at least some of the data in response to the at least one electronic survey.

13. The method of claim 7, wherein at least a portion of the data is received directly or indirectly from at least one sensor associated with an individual associated with the organization, or with an environment associated with the organization.

14. The method of claim 7, further comprising sending a signal indicative, at least in part, of the recommendation.

15. The method of claim 7, wherein at least some of the data is received from an electronic survey transmitted to an individual associated with the organization, a biometric sensor associated with an individual associated with the organization, or an environmental sensor associated with the organization.

16. A method for determining a recommendation for an organization, of the method comprising:
by a control circuit:
obtaining data related to at least one of a human capital trend or a social capital trend for an organization, the data including at least one of:
individual data received from an electronic at least one sensor associated with an individual associated with the organization or in response to an electronic survey, the individual data indicative of health or wellbeing, thriving, performance, motivation, or effectives of the individual;
organizational data received in response to an electronic survey transmitted to an individual associated with the organization, the organizational data indicative of organization performance, organizational culture, organizational engagement, risk management, or an environment of care for the organization;
environmental data received from at least one sensor associated with an environment associated with the organization or in response to an electronic survey, the environmental data indicative of environmental quality or perceptions of environmental quality associated with the organization;
community data received in response an electronic survey, the community data indicative of community engagement or stakeholder engagement of the organization; or
global data received in response to at least one electronic survey, the global data indicative of environmental, social, and global transparency or reporting for the organization;
automatically determining at least one recommendation based, at least in part, on the data; and
automatically implementing at least a portion of the at least one recommendation.

17. The method of claim 16, further comprising conducting market analysis based, at least in part, on the data.

18. The method of claim 16, wherein the at least one recommendation relates to at least one of the following:
at least one policy of the organization;
at least one obligation of the organization;
at least one strategy component of the organization;
at least one reporting activity of the organization;
at least one content creation activity of the organization;
at least one content sharing activity of the organization;
at least one strategy component of the organization;
at least one investment decision of the organization;
at least one feature of at least one product provided by the organization;
at least one feature of at least one service provided by the organization;
at least one feature of at least one product used by the organization;
at least one feature of at least one service used by the organization: or
at least one feature of at least one policy implemented by the organization.

19. The method of claim 16, further including automatically determining a benchmarking result for the organization based on the data, wherein the at least one recommendation is based, at least in part, on the benchmarking result.

20. The method of claim 16, further including automatically determining at least one reporting element for the organization based on the data, and implementing at least a portion of the at least one reporting element.
